(19) United States
(12) Patent Application Publication
(10) Pub. No.: US 2006/0069582 A1
(43) Pub. Date: Mar. 30, 2006

(54) System and method for community development

(76) Inventor: Frederick E. LaCroix, Dallas, TX (US)

Correspondence Address: HAYNES AND BOONE, LLP, 901 MAIN STREET, SUITE 3100, DALLAS, TX, 75202, US

(21) Appl. No.: 10/955,065

(22) Filed: Sep. 30, 2004

(51) Int. Cl. G06Q 99/00

(52) U.S. Cl. 705/1

(57) ABSTRACT

A method for community development is provided. A community platform is transported to and installed in an undeveloped area. A distribution system is connected to the community platform. At least one building in the undeveloped area is connected to the distribution system. Training is provided to a resident of the building. The community platform may comprise an electrification module, a water module, a refrigeration module, an entertainment module, and a communication module.

### BACKGROUND

More than a third of the world is without electricity. As a result, much of the word's population does not have access to adequate education, water, and communications infrastructure. Traditional approaches to developing market rural electrification are unable to survive without financial subsidies, and have proved unable to reconcile load adequacy, capacity restraints, and uses of electricity to enhance the community.

### DESCRIPTION OF THE DRAWINGS

FIG. 1 is a diagram of the four phases for community development in an embodiment of the present invention.

FIG. 2 is a community platform in one embodiment of the present invention.

FIG. 3 is an example operational flow of one embodiment of the present invention.

### DETAILED DESCRIPTION

This disclosure relates generally to community development and, more specifically, to a method for facilitating community development. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

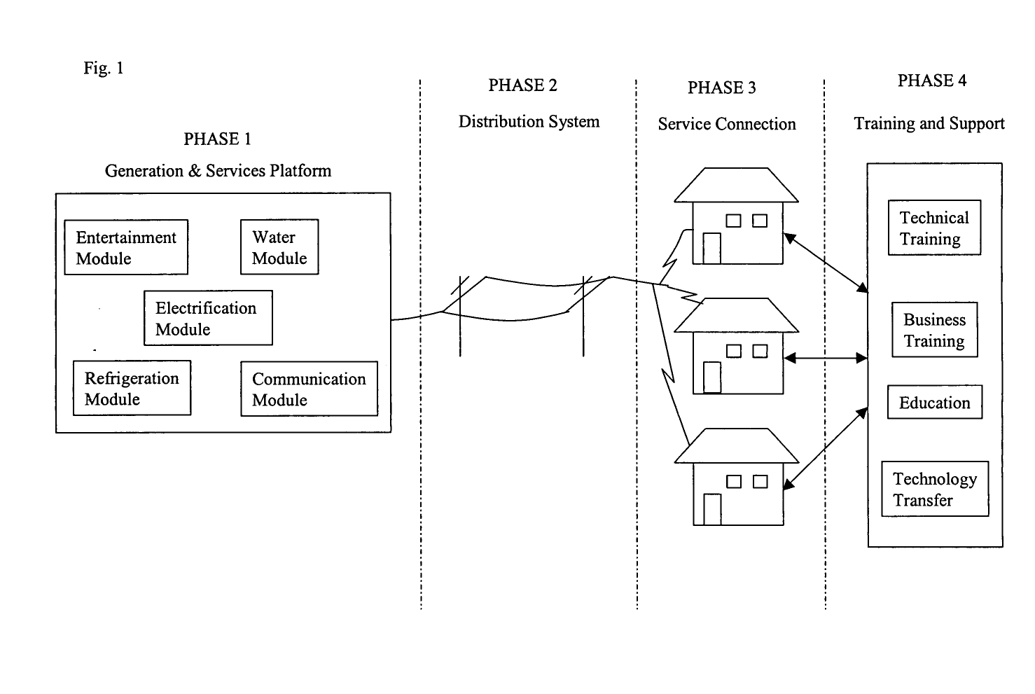

Referring now to FIG. 1, a diagram of the four phases for an undeveloped area electrification and development program in an embodiment of the present invention is shown. Phase 1 consists of installing the generation and services platform, or the community platform. In one embodiment, the community platform consists of an electrification module. In other embodiments, additional modules can be added to the community platform, including a water module, an entertainment module, and a refrigeration module. Other modules could also be added to the platform in accordance with the needs of the undeveloped area. For example, certain undeveloped areas may be suited for the growing of rice, and a module for processing rice could be added to the community platform.

Phase 2 consists of installing a distribution system. The distribution system is the system needed to conduct transmission of electricity. The distribution system may include poles, conductors, insulators, lines drops, and other distribution equipment readily understood to those skilled in the art. Depending on the undeveloped area's topography, location, and climate, the distribution system may be installed above ground or below ground. In one embodiment, the distribution system and the community platform may be installed concurrently.

Phase 3 consists of connecting the buildings in the undeveloped area to the distribution system. This allows for electricity to be transmitted from the community platform to the buildings in the undeveloped area.

Phase 4 consists of providing training and support to the residents of the undeveloped area. The training and support may include education, skills upgrading, technical training, and creation of local businesses.

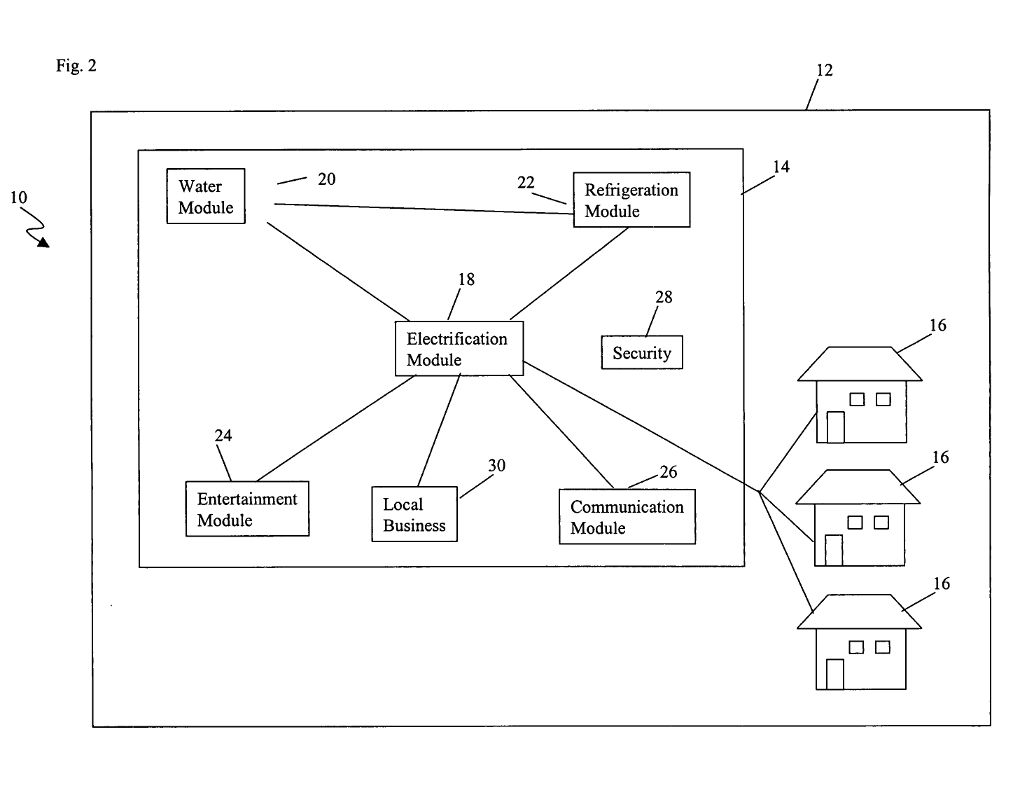

Referring now to FIG. 2, an example layout 10 of the community platform in an undeveloped area is shown. Undeveloped area 12 is a geographic location that is not connected to the electrical grid. The electrical grid is a network of infrastructure components that generate, transmit and distribute electricity. In addition, the undeveloped area 12 may have limited or no phone service. Within the undeveloped area 12 is the community platform 14 and the buildings 16 of the undeveloped area 12. The buildings 16 may be single family or multi-tenant residences, industrial buildings, or commercial buildings.

The community platform 14 may comprise a series of modules to facilitate the development of the undeveloped area 12. In this example, the community platform has an electrification module 18, a water module 20, a refrigeration module 22, an entertainment module 24, and a communication module 26. In addition, the community platform may have a security office 28. Further, local businesses 30 may also be a part of the community platform.

The electrification module 18 is a module that is able to generate electricity. In one embodiment, the electrification module 18 has a generator that is able to convert fuel into electricity. In a further embodiment, the electrification module 18 may use solar or wind power to generate electricity. In another embodiment, the electrification module 18 uses low sulfur diesel fuel to generate electricity. The electrification module 18 may be operated twenty-four hours a day, seven days a week, and include redundant systems to reduce outages or other failures. In another embodiment, the electrification module 18 is capable of being scaled with one or more additional electrification modules to provide additional electricity.

The water module 20 is a module that contains water purification and refilling equipment, deep-well and freshwater storage tank and pump, furniture and fixtures, utilities wiring and plumbing, or any combination of the foregoing. The water module 20 can be used by the residents to process or purify water. In one embodiment, the water module 20 contains systems to allow the filling of bottles with the purified or processed water. The water module's equipment may be connected to the electrification module 18 in order to receive electricity.

The refrigeration module 22 is a module that contains refrigeration units, an ice-making plant, furniture and fixtures, utilities wiring and plumbing, or any combination of the foregoing. The refrigeration module 22 is primarily designed to provide cold storage space and ice for the residents of the undeveloped area. In one embodiment, the refrigeration module 22 employs refrigeration compressors and related auxiliary equipment that are connected to the electrification module 18. In another embodiment, the refrigeration module 22 may be connected to the water module 20 so that purified or processed water can be used in the ice-making process.

The entertainment module 24 is a module that contains furniture and fixtures, utilities wiring and plumbing, movie projector, videoke (video/karaoke) machine and microphones, or any combination of the foregoing. As would be understood by one skilled in the art, the entertainment module 24 configuration could be modified in order to address the desires of the residents of area 12 for entertainment. In another embodiment, the entertainment module 24 could also include a concessions stand.

The communications module 26 is a module that contains furniture and fixtures, utilities wiring and plumbing, computers, telephones, fax, copier, scanner, and other communication devices, or any combination of the foregoing. The communications module 26 is primarily designed to facilitate computer usage, internet access, network gaming, computer printing, and telephone service. In one embodiment, the communications module 26 may use a GSM repeater link and cellular access stations to extend the reach of the communications transmitted from the communications module 26. In a further embodiment, the communications module 26 is connected to one or more other modules in the community platform 14 to provide computer-related functionality to the other modules, such as server/client networking or communication with electronic card readers for payment processing.

The modules within the community platform 14 may be customized to meet specific needs of the residents of the undeveloped area 12. For example, in one embodiment, the modules may be painted in a color scheme that has a particular cultural significance to the residents of the undeveloped area 12. In an additional embodiment, the modules can be configured to have electronic card readers for use in reading credit, debit, or prepaid electronic cards. In another embodiment, the electrification module 18 can be customized so that it can assimilated into the electrical grid, once the electrical grid reaches the undeveloped area 12.

Additionally, while the community platform 14 has been described as multiple, discrete modules, it is contemplated and expected that the different modules and functionality could be combined into one or more different modules without departing in scope from the present invention.

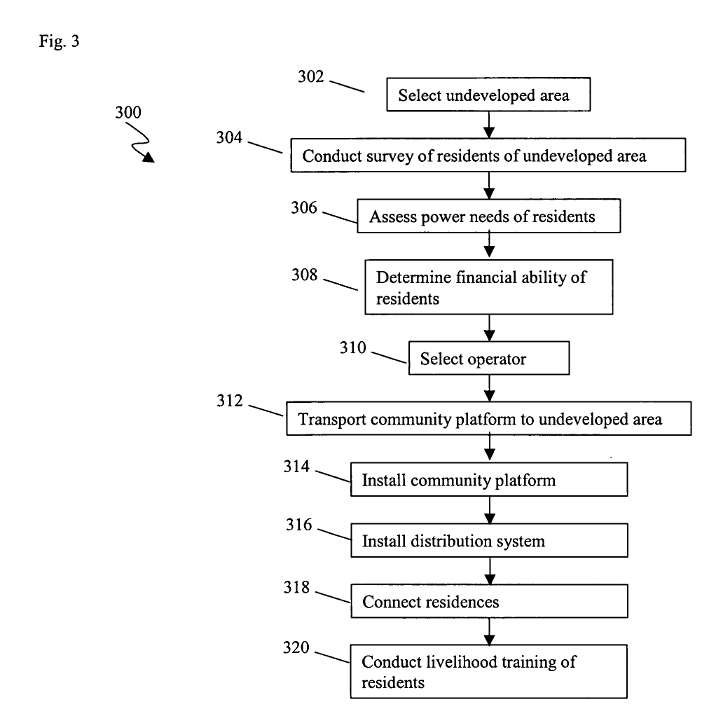

Referring now to FIG. 3, an example operational flow 300 of an embodiment of the present invention is shown. At step 302, an undeveloped area is selected. Regulatory requirements, industry structures, and sociopolitical climate may be some factors that are taken into account when selecting an undeveloped area. At step 304, a survey of the residents in the undeveloped area is taken. The survey may query the financial standing of the residents, businesses already operating in the undeveloped area, the perceived need and affect of a community platform in the undeveloped area, the benefit to and needs of residents for electricity, and the education level of the residents, as well as other factors.

At step 306, the results of the survey are used to determine the ability of the residents to use the community platform, as well as the ability to pay for usage of the community platform. The results of the survey can also be used to determine how much electricity would be needed by the residents, and the number and output capability of the electrification module in the community platform. At step 310, a local operator is selected to manage the community platform. In one embodiment, the operator may be a locally based individual or company. The local operator is tasked with providing local training, technology transfer and employment opportunities with respect to the community platform. The operator may also be tasked with conducting preventative and remedial maintenance of the different modules in the community platform. The operator may also operate the businesses within different modules within the community platform and collects payment from the residents for their usage of the modules. The operator may hire and manage local staff to operate the businesses within the modules in the community platform. In one embodiment, the operator collects payments from the residents on behalf of the provider of the community platform. In another embodiment, the operator receives a commission from the provider of the community platform based on the amounts of payments collected by the operator. In another embodiment, a local operator is chosen for each module in the community platform. In a further embodiment, a local operator is chosen to manage the community platform, and other operators are chosen to manage the individual modules in the community platform. In yet another embodiment, in addition to selecting a local operator, local residents could be appointed to be local concession holders for particular modules. For example, a resident could appointed to run a concessions stand in the entertainment module.

At step 312, the community platform is transported to the undeveloped area. In one embodiment, the community platform may be manufactured using locally sourced or imported materials and labor. In another embodiment, the community platform is assembled prior to shipping to the installation site. Transporting the community platform to the installation site may be by airlift, helicopter, or land transportation.

At step 314, the community platform is installed at the undeveloped area. The installation may involve clearing land and connecting the different modules of the community platform to each other. In addition, the installation may include erecting a wall, fence, or other obstruction around the community platform. Further, the installation may also involve creating roads and sidewalks, both inside the community platform as well as in the undeveloped area. The roads and sidewalks may dirt, gravel, cobblestone or paved. Additionally, the installation of the community platform may include placing trees, fountains, statues or objects tailored to the social and/or cultural customs and needs of the residents of the undeveloped area.

At step 316, the distribution system is installed at the undeveloped area. The distribution system is connected to the electrification module. The distribution system may include poles, conductors, insulators, lines drops, and other distribution equipment readily understood to those skilled in the art. Depending on the undeveloped area's topography, location, and climate, the distribution system may be installed above ground or below ground. In one embodiment, the distribution system and the community platform may be installed concurrently. At step 318, the distribution system is connected to the residences of the residents of the undeveloped area.

At step 320, the livelihood training for residents of the undeveloped area is conducted. The training may be conduced by the local operator or the provider of the community platform. The training and support may include education, skills upgrading, technical training, and creation of local businesses. In one embodiment, the residents are trained in how to use the community platform to create or enhance a local business.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A method for community development, comprising:
transporting an electrification module to a geograhic location that is not connected to an electrical grid;
transporting a water module to the geographic location;
installing the electrification module in the geographic location;
installing the water module in the geographic location:
connecting an electrical distribution system to the electrification module;
connecting the water module to the electrical distribution system;
connecting at least one building, which was in the geographic location prior to the transporting of the electrification module, to the electrical distribution system; and
facilitating the training of at least one resident of the geographic location in the operation of the electrification module.

2. (canceled)

3. (canceled)

4. (canceled)

5. (canceled)

6. The method of claim 1, further comprising:
installing a refrigeration module in the geographic location.

7. The method of claim 6, further comprising:
connecting the electrification module and the refrigeration module.

8. The method of claim 6, further comprising:
connecting the water module to the electrification module and the refrigeration module.

9. The method of claim 1, further comprising:
assessing electricity needs of the at least one resident; and
determining a scale of the electrification module based on the electricity needs.

10. The method of claim 1, further comprising:
conducting a survey to assess the electricity needs of the geographic area.

11. The method of claim 1, further comprising:
determining a financial ability of the at least one resident.

12. The method of claim 1, further comprising:
receiving at least one payment from the at least one resident.

13. The method of claim 1, further comprising:
establishing a collector of payments in the geographic area.

14. The method of claim 13, further comprising:
paying a commission to the collector of payments.

15. The method of claim 1, further comprising:
establishing a color scheme for the electrification module that corresponds to the geographic area.

16. The method of claim 1, further comprising:
generating electricity at the electrification module using a generator.

17. The method of claim 1, wherein the facilitating of training facilitates training of the at least one resident in the use of the water module.

18. A method for community development, comprising:
conducting a survey to assess the needs of an undeveloped area;
determining a scale of a community platform in accordance with the survey;
determining the financial ability of a plurality of residents in the undeveloped area;
establishing a color scheme that corresponds to the undeveloped area;
applying the color scheme to the community platform;
installing the community platform in the undeveloped area;
connecting a distribution system to the community platform;
connecting at least one building to the distribution system;
providing training to at least one resident of the at least one building;
establishing a collector of payments in the undeveloped area; and
receiving at least one payment from the at least one resident.

19. The method of claim 18, wherein the community platform comprises an electrification module, a water module, and a refrigeration module.

20. The method of claim 18, wherein the community platform comprises a communication module and an entertainment module.
